(19) United States
(12) Patent Application Publication
(10) Pub. No.: US 2015/0337470 A1
(43) Pub. Date: Nov. 26, 2015

(54) Dimensionally Stable Carpet

(71) Applicant: Tandus Centiva Inc., Dalton, GA (US)

(72) Inventors: Paul Daniel Evans, JR., Sugar Valley, GA (US); Terrell Bradley Marler, Hixson, TN (US)

(21) Appl. No.: 14/718,903

(22) Filed: May 21, 2015

Related U.S. Application Data
(60) Provisional application No. 62/002,627, filed on May 23, 2014.

(51) Int. Cl. D05C 17/02; B26D 5/00; B26D 3/10; E04F 15/10; B26D 1/45

(52) U.S. Cl. CPC D05C 17/02; D05C 17/023; E04F 15/102; B26D 1/455; B26D 3/10; B26D 5/00

(57) ABSTRACT

A floor-covering article has an upper layer with yarns that extend through a primary backing and are at least partially secured to the primary backing by polymeric material, wherein the yarns define an exterior upper surface of the article; an intermediate layer connected to the upper layer; and a secondary backing connected to the intermediate layer so that the intermediate layer is positioned between the upper layer and the secondary backing. The article includes cut peripheral side edges. The length and/or width of the article can be at least about 3 feet. At least one of the peripheral side edges of the secondary backing can define an upright, outwardly-oriented side face extending obliquely to the bottom surface of the secondary backing.

### CROSS-REFERENCE TO RELATED APPLICATION

This application claims the benefit of U.S. Provisional Patent Application No. 62/002,627, which was filed on May 23, 2014, the entire contents of which are incorporated herein by reference.

### BACKGROUND

It is common for tufted carpet to be sold in rolls that include about 150 feet of carpet and are about 12 or 13 feet wide, or wider. During manufacturing while the carpet is traveling in the machine direction and closely upstream from being formed into a roll, it is typical for right and left margins of the carpet to be cut off as they travel past stationary cutters, to form cut right and left edges of carpet. The right and left margins and edges extend in the machine direction. The right and left margins that are cut off each may be about an inch wide and extend for the entire length of the carpet, resulting in a significant amount of scrap. The carpet typically drifts right and/or left while the margins are being cut off, so that the cut right and left cut edges are not perfectly straight.

During installation of the carpet, the right and left edges that were cut during original manufacturing are typically not straight enough to form satisfactory seams without further cutting along these edges. For example, even if the right and left edges were cut straight during original manufacturing, it is common for flexible carpets to stretch or otherwise become misshaped prior to seaming, so that the edges cut during original manufacturing are typically not straight enough for forming satisfactory seams. Therefore and for example, for each pair of adjacent pieces of carpet being installed, the adjacent margins of the pieces may be overlapped and simultaneously cut through to provide newly cut edges that will together form a satisfactory seam. As a result, strips may be cut off of numerous pieces of the carpet during installation, resulting in a significant amount of scrap that is in addition to the scrap cut off during original manufacturing, as discussed above. Unfortunately, the overlapping and cutting during installation is labor intensive and time consuming, and it contributes to the further creation of wasteful scraps.

### SUMMARY

An aspect of this disclosure is the provision of a finished article for covering a floor, where the finished article may include: an upper layer having yarns that extend through a primary backing and are at least partially secured to the primary backing by polymeric material, wherein the yarns at least partially define an exterior upper surface of the finished article; an intermediate layer connected to the upper layer; and a secondary backing connected to the intermediate layer so that the intermediate layer is positioned between the upper layer and the secondary backing, wherein the finished article includes at least three cut peripheral side edges, at least two of the cut peripheral side edges extend crosswise to one another, and the length and/or the width of the finished article may be at least about 3 feet, at least about 6 feet, or at least about 10 feet. In one example, the intermediate layer includes fiberglass scrim.

The finished article may be a first finished article that is part of a floor covering that further includes a second finished article. A lengthwise engagement between a cut peripheral side edge of the first finished article and a cut peripheral side edge of the second finished article may extend for at least about 3 feet, at least about 6 feet, or at least about 10 feet.

In accordance with an aspect of this disclosure, an article for covering a floor may include: a backing having opposite top and bottom surfaces, wherein the backing includes a textile web and polymeric material; and a plurality of yarns extend upwardly from the backing, wherein the yarns extend through the textile web and are at least partially secured to the textile web by the polymeric material, and wherein the backing includes a peripheral side edge defining an upright, outwardly-oriented side face extending both along the length of the article and between the top and bottom surfaces of the backing, and the side face extends obliquely to both of the top and bottom surfaces of the backing. The side face may extend straight or curvilinearly along the length of the article.

The side edge may be a first side edge, and the backing may further include second, third and fourth side edges. The first and second side edges may be spaced apart from one another. The third and fourth side edges may be spaced apart from one another. The third and fourth side edges may each extend between the first and second side edges. For each side edge of the second, third and fourth side edges, the side edge may define an upright, outwardly-oriented side face extending between the top and bottom surfaces of the backing, and the side face may extend obliquely to both of the top and bottom surfaces of the backing.

In an aspect of this disclosure, a floor covering may include a plurality of articles covering a floor, wherein the plurality of articles includes first and second articles that each include a backing having opposite top and bottom surfaces, and a plurality of yarns connected to the backing and extending upwardly from the top surface of the backing. For each article of the first and second articles, the backing of the article may include a peripheral side edge defining an upright, outwardly-oriented backing side face extending both along the length of the article and between the top and bottom surfaces of the backing, and the backing side face may extend obliquely to both of the top and bottom surfaces of the backing. The yarns along the side edge of the first article may be in opposing face-to-face engagement with the yarns along the side edge of the second article. The backing side face of the first article may be in opposing face-to-face relation with the backing side face of the second article along the lengths of the first and second articles. An elongate gap may be defined between at least a lower portion of the backing side face of the first article and the backing side face of the first article. The elongate gap may extend along the lengths of the first and second articles, such as for a distance of at least about 3 feet, at least about 6 feet, or at least about 10 feet.

An aspect of this disclosure is the provision of a method for at least partially forming an article configured for covering a floor. The method may include cutting a peripheral side edge of the article, wherein the article may include a backing having opposite top and bottom surfaces, and a plurality of yarns connected to the backing and extending upwardly from the top surface of the backing. The cutting of the peripheral side edge may be comprised of cutting so that the peripheral side edge includes an upright, outwardly-oriented side face extending both along the length of the article and between the top and bottom surfaces of the backing, and the side face extends obliquely to both of the top and bottom surfaces of the backing. The cutting of the peripheral side edge may be comprised of a computerized cutting machine moving a cutter along the length of the peripheral side edge to cut the peripheral side edge. The cutting may include simultaneously cutting two of the articles with the same knife.

In accordance with an aspect of this disclosure, the cutting of the peripheral side edge of an article may include at least partially forming a parting line in the yarns of the article in advance of a moving cutter, so that the parting line is formed in advance of, and is substantially aligned with, the cut line being formed in the backing by the moving cutter.

Another aspect of this disclosure is the provision of a knife that may be used to simultaneously cut the two articles. The knife may include a shank having length and a longitudinal axis extending along the length of the shank, and a cutting blade extending fixedly from the shank, wherein the cutting blade has a longitudinal axis extending along the length of the cutting blade, and the longitudinal axis of the cutting blade extends obliquely to the longitudinal axis of the shank. The cutting blade may be a first cutting blade, and the knife may further include a second cutting blade extending fixedly from the shank. The second cutting blade may have a longitudinal axis extending along the length of the second cutting blade. The longitudinal axis of the second cutting blade may extend obliquely to the longitudinal axis of the shank. The longitudinal axes of the first and second blades may extend divergently from one another in a direction away from the shank.

The foregoing presents a simplified summary of some aspects of this disclosure in order to provide a basic understanding. The foregoing summary is not an extensive summary of the disclosure and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

In the following, reference is made to the accompanying drawings, which are not necessarily drawn to scale and may be schematic. The drawings are exemplary only, and should not be construed as limiting the invention.

FIG. 1A is a cut-away, partially exploded view of a section of a floor covering product comprising tufted carpet, in accordance with an exemplary embodiment of this disclosure.

FIG. 1B illustrates a portion of the assembled carpet of FIG. 1A that includes yarns looped through a primary backing and secured thereto by a precoat layer.

FIGS. 2 and 3 schematically illustrate aspects of forming a seam between floor covering articles of the type described with reference to FIGS. 1A and 1B, in accordance with an example of the exemplary embodiment.

FIG. 4 is a schematic top plan view of a room in which floor covering articles of the type described with reference to FIGS. 1A and 1B have been installed, wherein the pieces collectively form a floor covering or carpet assembly extending from wall to wall, and FIG. 4 is illustrative of one of numerous configurations that are within the scope of this disclosure.

FIG. 5. is like FIG. 4, except for being illustrative of an example of how the floor covering may be repositioned in the room.

FIG. 6 is a cross-sectional view taken through a representative one of the peripheral side edges of the floor covering articles, wherein for example, the cross section may be taken along any of lines 6-6 of FIG. 2 or at any other position along the length of the peripheral side edges of the floor covering articles.

FIG. 7 is a cross-sectional view taken through a representative one of the seams between the floor covering articles, wherein for example, the cross section may be along line 7-7 of FIG. 3 or at any other position along the length of the seam between floor covering articles.

FIG. 8 is a top plan view of floor covering articles positioned on downdraft table of a cutting machine, in accordance with an example of a method of cutting the floor covering articles from a product that may be in the form of tufted carpet.

FIG. 9 illustrates other features of the cutting machine.

FIG. 10 is a front elevation view of an example of a knife that may be used with the cutting machine.

FIG. 11 is a left, side elevation view of the knife of FIG. 10. A right, side elevation view of the knife of FIG. 10 is a mirror image of FIG. 11.

FIG. 12 is like FIG. 8, except that the cut lines between the adjacent floor covering articles are straight in FIG. 8, whereas they are curvilinear in FIG. 12.

FIGS. 13-15 are isolated plan views of examples of floor covering articles with curvilinear side edges.

FIG. 16 illustrates a separator being transported proximate a knife for at least partially forming a parting line in the pile yarns, so that the parting line is formed in advance of the advancing knife and is substantially aligned with the cut line being formed in the backing by the advancing knife, in accordance with an embodiment of this disclosure.

FIG. 17 is similar FIG. 16 except, for example, for showing a different type of separator.

### DETAILED DESCRIPTION

Exemplary embodiments are described below and illustrated in the accompanying drawings, in which like numerals refer to like parts throughout the several views. The embodiments described provide examples and should not be interpreted as limiting the scope of the invention. Other embodiments, and modifications and improvements of the described embodiments, will occur to those skilled in the art, and all such other embodiments, modification, and improvements are within the scope of the present invention.

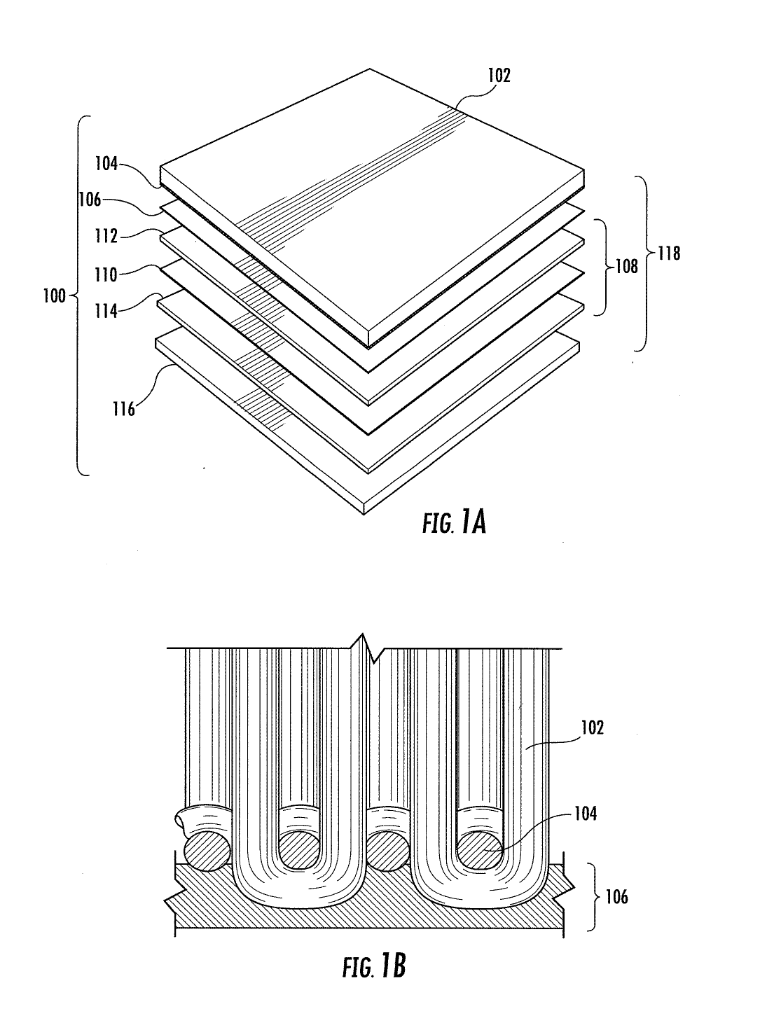

Referring in greater detail to the drawings, FIG. 1A is a cut-away, partially exploded view of a portion of an exemplary textile product 100, for example, an article in the form of tufted carpet (e.g., carpet roll good). The carpet 100 includes numerous tufted pile yarns 102 that define an upper side or face of the carpet. More generally, the pile yarns 102 may at least partially define an exterior upper surface of the carpet 100 or articles cut from the carpet. The pile yarns 102 may be cut to form cut pile tufts or may be left as uncut loops. The pile yarns 102 may be made of synthetic and/or natural fibers, such as polyamides (e.g., nylon), polypropylene, polyester, polyacrylonitrile, wool, sisal and/or any other suitable materials. A protectant may be applied to the top surface of the yarns 102. For example, the protectant may comprise a frothed fluorochemical and/or any other suitable material.

Referring also to FIG. 1B, the yarns 102 may extend through, such as by being looped or at least partially looped through, a primary backing 104. The primary backing 104 may comprise a textile web that may be a woven or nonwoven scrim material, such as a nylon nonwoven, a polyester nonwoven, or other suitable material. A precoat layer 106 may secure the pile yarns 102 to the primary backing 104 to form an upper layer of the carpet 100. The precoat layer 106 may be a vinyl acetate ethylene copolymer and/or other suitable polymeric materials, or the like.

Referring to FIG. 1A, a reinforcing and/or sealing intermediate layer 108 may be adhered to and/or otherwise mounted to the precoat layer 106 and/or the primary backing 104 using any suitable technique, for example, lamination, adhesive, stitching, or otherwise. The intermediate layer 108 may comprise a reinforcing layer 110. The reinforcing layer 110 may comprise, consist essentially of, or consist of a fiberglass mesh, nonwoven scrim, a fiberglass nonwoven scrim and/or any other suitable material. The reinforcing layer 110 may be adhered to and/or otherwise attached to the precoat layer 106 and/or the primary backing 104 using any suitable technique, for example, lamination, adhesive, stitching, or otherwise. More specifically, the intermediate layer 108 further includes secondary and tertiary layers or coatings 112, 114. That is, the reinforcing layer 110 may be coated on at least one side, such as by being coated on both sides respectively with the secondary and tertiary coatings 112, 114. The secondary coating 112 may be disposed between the precoat layer 106 and reinforcing layer 110 for binding them together. Similarly, the tertiary coating 114 may be disposed between the reinforcing layer 110 and a lower layer or secondary backing 116 for binding them together. The secondary and tertiary coatings 112, 114 may comprise plastisol, or more specifically polyvinyl chloride (PVC) plastisol, and/or any other suitable material.

The primary backing 104, precoat layer 106, intermediate layer 108, reinforcing layer 110, coatings 112, 114 and secondary backing 116 may be collectively referred to as a composite backing 118 having opposite top and bottom surfaces. The yarns 102 are connected to the composite backing 118 and extend upwardly from the top surface of the composite backing 118. Whereas an example of the composite backing 118 is described in detail above and in the following, it is within the scope of this disclosure for there to be variations in the construction of the composite backing and components thereof.

Generally described, the secondary backing 116 may be adhered to and/or otherwise attached to the reinforcing layer 110 using any suitable technique, for example, lamination, adhesive, stitching, or otherwise. More specifically and reiterating from above for the exemplary embodiment, the tertiary coating 114 may be disposed between the reinforcing layer 110 and the secondary backing 116 for binding them together. As one example, the secondary backing 116 may be substantially like the backing disclosed in U.S. Pat. No. 8,669,297, which is incorporated herein by reference, in its entirety.

The secondary backing 116 may comprise any suitable material, and in some instances it may comprise a flexible polymeric matrix comprising, for example, PVC. In the exemplary embodiment, the secondary backing 116 comprises a closed cell foam including a plurality of gas pockets or cells (not shown in FIG. 1A), wherein the foam functions at least as a cushion, such that the carpet 100 may be characterized as being pre-cushioned, and finished articles (discussed below) formed from the carpet may also be characterized as being pre-cushioned. The cells may be voids or may contain air or gases, such as decomposition products of a foaming agent and/or blowing agent. However, in other embodiments, the secondary backing 116 may be an open cell structure or a combination of open and closed cells. The secondary backing 116 may serve as a resilient cushion that will compress under an external load and recover when the load is removed. In general, the greater the percentage of closed cells in the structure, the better the cushioning properties of the reinforcing layer and/or the better moisture resistance. While the use of foam (i.e., foamed) backings is described in detail herein, it should be understood that non-foam (i.e., non-foamed) backings also may be used.

If desired, the secondary backing 116 may include a reinforcing layer or material (not shown in FIG. 1A). The reinforcing layer of the secondary backing 116 may comprise, consist essentially of, or consist of a fiberglass mesh, nonwoven scrim, a fiberglass nonwoven scrim and/or any other suitable material. The reinforcing layer or material may be embedded within the secondary backing 116 or may be joined to one or both faces of the secondary backing.

The reinforcing layer of the secondary backing 116 may comprise from about 1 to about 5 wt % of the secondary backing, for example, about 2 to about 4 wt % of the secondary backing, for example, about 3 wt % of the secondary backing. The blowing agent of the secondary backing 116 may comprise from about 1 to about 3 wt % of the secondary backing, for example, about 2 wt % of the secondary backing. Thus, where both components are present, the mesh reinforcing layer and blowing agent may collectively comprise from about 2 to about 8 wt % of the secondary backing 116, for example, from about 3 to about 7 wt % of the secondary backing, for example, about 5 wt % of the secondary backing.

In an example of a method of forming the secondary backing 116, PVC in the form of pellets and a blowing agent may be fed into an extruder (with any other additives) and heated to form an extrudable mixture or composition. The extrudable mixture may then be extruded generally as a rope, calendered (optionally with the reinforcing layer) to form a sheet, and optionally trimmed. The blowing agent may then be activated by passing the sheet through an oven at a temperature above the activation temperature of the blowing agent to form the secondary backing 116. In one example, the blowing agent may comprise azodicarbonamide, which has an activation temperature of about 350-395° F. However, other blowing agents may be used. The PVC and optional blowing agent may be combined in any suitable relative amounts. In each of various independent examples, the extrudable mixture or composition may include from 0 to about 3 wt % blowing agent, and the remainder may be PVC, or any other suitable composition. In other examples, the extrudable mixture or composition may include about 2 wt % blowing agent, and the remainder may be PVC, or any other suitable composition. However, other compositions may be suitable.

The composition of the resulting secondary backing 116 may likewise vary. In each of various independent examples, the secondary backing may include from 0 to about 3 wt % blowing agent and from 0 to about 4 wt % reinforcing layer, and the remainder may comprise, consist of, or consist essentially of PVC, or any other suitable composition. In one particular example, the secondary backing 116 may comprise about 2 wt % blowing agent, about 3 wt % reinforcing layer, and the remainder may comprise, consist of, or consist essentially of PVC, or any other suitable composition. However, other secondary backing compositions are contemplated hereby.

In an example of a method of this disclosure, a relatively long and wide piece of the carpet 100 may be formed into a roll after being manufactured. For example, the roll may include about 150 feet of the carpet 100 and may be about 12 or 13 feet wide, or wider. A variety of differently sized rolls of the carpet 100 are within the scope of this disclosure, and in some instances the step of forming the carpet into a roll may be omitted. After the carpet 110 is formed into a roll, lengths of the carpet may be unwound from the roll and cut in predetermined shapes and sizes, to create finished articles. In the exemplary embodiment, the cutting is performed so that edges of the finished articles are substantially perfectly straight, and for finished articles in the form of rectangles the corners are substantially perfect right angles. Also in the exemplary embodiment, the carpet 100 is configured to remain dimensionally stable throughout normal handling and usage of the carpet and the finished articles cut therefrom, so that the edges of the finished articles remain substantially perfectly straight, and for finished articles in the form of rectangles the corners remain substantially perfect right angles. Similarly, the precoat 116, coatings 112, 114 and other features of the carpet 100 are configured in a manner that seeks to prevent any delamination, edge ravel, zippering and other defects in the carpet and finished articles for extended periods of time. That is, the finished articles of the exemplary embodiment are dimensionally stable in their length and widthwise directions, and durable, while at the same time being sufficiently flexible so that finished articles of sufficient length may be formed into rolls.

For example, the cutting of the substantially perfectly straight edges and the substantially perfect right angles, or the like, may be carried out through the use of a conventional computerized numeric control (CNC) cutting machine including a horizontal support table for supporting the carpet 100 to be cut, a longitudinally movable gantry positioned above the table, a transversely movable carriage mounted on the gantry, and a cutter carried by the carriage. The cutter may be in the form of a conventional ultrasonic cutting device, wherein an ultrasonic transducer converts high frequency electrical energy into high frequency mechanical energy (e.g., vibrations) that are imparted upon a movably mounted cutting blade for cutting the finished articles from the carpet 100. For example, the CNC cutting machine may cut the adjacent edges 124 so that they match each other perfectly (e.g., substantially perfectly), irrespective of where the adjacent edges are positioned in a floor covering assembly, irrespective of whether the adjacent edges are beveled (as discussed in greater detail below), and irrespective of whether the adjacent edges are curvilinear (as discussed in greater detail below).

Examples of the finished articles may include roll goods in the form of rectangular pieces of the carpet 110 that are up to 6 feet wide and any suitable length, such as a length of up to about 32 feet or a length up to about 67 feet, wherein these finished articles are typically formed into rolls for ease of moving them (e.g., they may be roll goods). Other examples of the finished articles include rectangular pieces of the carpet 110 that are 10 feet wide and 10 feet long, rectangular pieces of the carpet that are 1 foot wide and 10 feet long, rectangular pieces of the carpet that are 8 inches wide and 10 feet long, triangular pieces that are 3 feet (e.g., a length of 3 feet) by 1.5 feet (e.g., a width of 1.5 feet), and/or any other suitable pieces. For example, the finished articles may have a length and a width, wherein the length and/or the width may be at least about 3 feet, at least about 6 feet, at least about 10 feet. For example, the finished articles may have a length, wherein the length may be in a range of from about 3 feet to about 32 feet, from about 3 feet to about 67 feet, from about 6 feet to about 32 feet, from about 6 feet to about 67 feet, from about 10 feet to about 32, from about 10 feet to about 67 feet, any subranges therebetween, or any other suitable length.

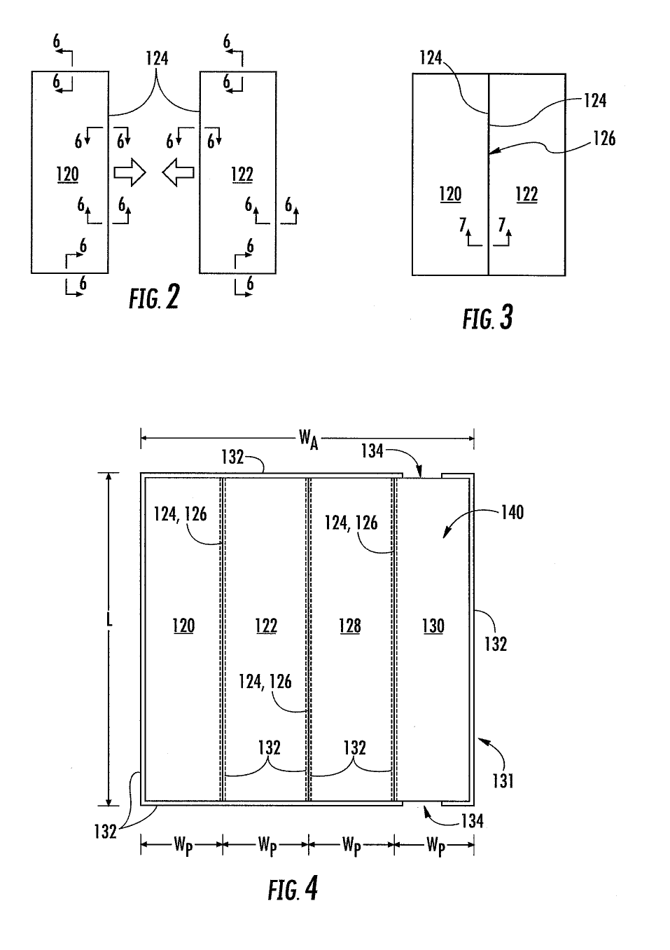

In an example of a method of this disclosure, since the finished articles are dimensionally stable and have substantially perfectly straight edges and corners that are in the form of substantially perfect right angles, or the like, the finished articles are ready to be installed without any further cutting, at least in the central area of the installation. In this regard and more specifically, each of a plurality of finished articles may optionally be shipped in the form of respective rolls to an installation site. More specifically, a first roll of the finished articles may consist of a first finished article, and a second roll of the finished articles may consist of a second finished article. The first and second finished articles may be unrolled at the installation site. Referring to the specific example shown in FIGS. 2 and 3, the first and second finished articles 120, 122 in a flattened configuration may be aligning with one another and may be pushed together so that the aligned adjacent edges 124 of the finished articles are engaged against one another to form a seam 126. In accordance with the exemplary embodiment, the adjacent edges 124 were originally cut substantially perfectly straight prior to shipping to the installation site, and the articles 120, 122 are substantially dimensionally stable, so that the adjacent edges 124 are substantially perfectly straight throughout and subsequent to installation, and so that the formed seam 126 is substantially perfectly straight, without requiring any additional cutting. Alternatively, the articles 120, 122 may be further cut at the installation site if necessary or desired.

For securing the seam 126 with the adjacent edges 124 firmly engaged against one another for their entire lengths, the first and second finished articles 120, 122 may be secured together in any suitable manner. For example, for the finished articles having lengths of 20 feet or greater, for each seam 126 a length of seam sealer that comprises, consists of, or consists essentially of adhesive material may underlie the seam, extend across seam, and extend along at least a portion of, or extend along substantially all of, the seam. In one example, adhesive tape may be used as the seam sealer, wherein the adhesive material may be coated on one side of the tape, so that the lower face of the tape may be absent of any adhesive material, whereas the upper surface of the tape may include adhesive material. When adhesive tape is used, the adhesive material may a pressure-sensitive adhesive material, a heat-activatable adhesive material and/or any other suitable adhesive material. The heat-activatable adhesive material may be a thermoplastic polymeric material that may be activated using a carpet seaming iron, or in any other suitable manner. For the relatively smaller finished articles, a piece of tape may underlie and span across adjacent corners of adjacent finished articles, and optionally separate pieces of the tape may underlie the seams at four foot intervals, wherein the upper face of the tape includes adhesive material and the lower face may not include any adhesive material.

As further examples of suitable fastening mechanisms and methods for securing the seams 126 without adhering the finished articles 120, 122 to the underlying floor, after the articles are initially arranged so that the adjacent edges 124 are firmly engaged against one another, the adjacent edges may be pulled upwardly and away from one another, and any suitable protective or shielding material may be positioned on the underlying floor so as to underlie the seams, then adhesive material may be placed upon the upper surface of the shielding material, and then the adjacent edges 124 may be moved downwardly and toward one another so that they are again firmly engaged against one another and become securely connected to one another by the adhesive material. For example, the protective or shielding material for being placed on the upper surface of the underlying floor and supporting the adhesive material may be a paste wax, paper such as kraft paper and/or any other suitable material, and the adhesive material may be a water-based adhesive material and/or any other suitable adhesive material.

For illustrating and expanding upon some of the above-discussed aspects of this disclosure, FIG. 4 is a schematic top plan view of the finished articles 120, 122 and additional finished articles 128, 130 installed in a room 131, as one of countless examples that are within the scope of this disclosure. In the example shown in FIG. 4, the rectangular room 131 includes four upright walls 132, some of which include doorways 134. The finished articles 120, 122, 128, 130 have been installed edge 124 to edge 124 as discussed above so that the seams 126 are secured by elongate underlying fastening mechanisms 136 that may comprise, consist essentially of, or consist of adhesive material. The fastened together finished articles 120, 122, 128, 130 form an assembly of finished articles, wherein the assembly of finished articles may be referred to as a textile assembly or a carpet assembly 140. The outer peripheral edges of the carpet assembly 140 may engage substantially perfectly against the baseboards, or the like, of the walls 132. In addition, the finished articles 120, 122, 128, 130 may have been initially cut (e.g., with the above-discussed CNC machine) to appropriate lengths and widths, with substantially perfectly straight edges and corners that are substantially perfect right angles, and formed into rolls prior to being transported to the room 131, so that the finished articles 120, 122, 128, 130 may have been installed in the room without requiring any cutting subsequent to the initial cutting. FIG. 4 is schematic because, for example, the seams 126 are typically not readily visible with the naked eye unless inspected closely, and the fastening mechanisms 132 are hidden from view and, thus, schematically illustrated with dashed lines.

FIG. 4 may be illustrative of a first installation of the finished articles 120, 122, 128, 130, wherein the finished articles and fastening mechanism 136 collectively form the carpet assembly 140 extending from wall to wall. FIG. 5. is like FIG. 4, except for being illustrative of a subsequent, second installation of the carpet assembly 140, as discussed in greater detail below.

In the example of FIG. 4, over an extended period of time the foot traffic between the doorways 134 may cause the finished article 130 to wear more than the finished articles 120, 122, 128. Accordingly and as an example of a method of this disclosure, FIGS. 4 and 5 illustrate the same carpet assembly 140 before and after it has been rotated 180 degrees. That is, FIGS. 4 and 5 are identical except that the carpet assembly 140 has been rotated 180 degrees in FIG. 5 as compared to FIG. 4. More specifically and for refreshing the appearance of the most used portions of the carpet assembly 140, the carpet assembly as shown in FIG. 4 may be at least partially formed into a roll, or the like, by rolling about a horizontal axis; then the at least partially rolled up carpet assembly may be rotated 180 degrees about a vertical axis; and then the at least partially rolled up carpet may be unrolled to result in the arrangement of the carpet assembly shown in FIG. 5. This rearranging may be conducted while maintaining one or more of, such as all of, the seams 126 of the carpet assembly 140 in their secured together configuration with the respectively associated fastening mechanisms 136. Alternative, the rearranging may comprise one or more of the seams 126 being unseamed, and thereafter reseamed, or the like.

As one specific example, the length L of the room 131 (measured between the respective walls 132), finished articles 120, 122, 128, 130 and carpet assembly 140 may be substantially the same, such as by being 24 feet or any other suitable length; the widths W_{A} of the room 131 (measured between the respective walls 132) and carpet assembly 140 may be substantially the same, such as by being 24 feet or any other suitable width; and the widths Wₚ of each of the finished articles 120, 122, 128, 130 may be 6 feet or any other suitable width. Those of ordinary skill in the art will understand that countless other examples are within the scope of this disclosure,

At least partially reiterating from above for the exemplary embodiment, the finished articles (e.g. 120, 122, 128, 130) may be installed in a manner such that they are not adhered to the underlying floor, and after the original installation the finished articles may be rearranged and/or redistributed (e.g., optionally separated from one another along the seams 126, optionally rolled up, and then reinstalled in an interchanged arrangement) in a manner that seeks to refresh the carpet assembly (e.g., 140), or the like. The finished articles (e.g. 120, 122, 128, 130) may be characterized as being modular and portable, such that they may be moved and reinstalled in a different location and/or configuration as compared to the original installation. The finished articles (e.g. 120, 122, 128, 130) may be precisely precut so that they may be installed without requiring cutting at the installation site(s), although the finished articles may optionally be further cut at the original and/or subsequent installation site. Alternatively, the finished articles may be installed and used in any suitable manner.

As indicated above, the cutting of the finished articles so that they have substantially perfectly straight edges and substantially perfect right angles, or the like, may be carried out through the use of a conventional CNC cutting machine. Alternatively, a conventional stamping (e.g., cutting) press may be used in a manner that seeks to provide the finished articles so that they have substantially perfectly straight edges and substantially perfect right angles, or the like. However, using an ultrasonic cutter may reduce the amount of wasted pile yarn 102 as compared to using a conventional press. A conventional press typically includes a feature that holds the tufted carpet in place and then the cutting blade come straight down to cut the tufted carpet. The feature that holds the tufted carpet in place typically knocks pile yarns 102 over on their sides so that the cutting creates clipped loops and separated yarn fluff. In contrast, the ultrasonic cutting may be more likely to allow a loop of pile yarn 102 that is just to one side of the cut to be pushed back to its side rather than the top of the loop being cut off, or the like.

The above-discussed substantially perfectly straight edges and substantially perfect right angles, or the like, are typically present in top and bottom plan views of the finished articles in a flat configuration. Simultaneously therewith, for at least some of or each of the finished articles, each or at least some of the peripheral edges of the finished article may optionally be at least partially undercut and/or beveled. As a more specific example for each of the finished articles, the peripheral edges of at least the secondary backing 116 may be beveled so that they extend inwardly from the relatively larger top surface of the secondary backing to the relatively smaller bottom surface of the secondary backing. That is, at least the peripheral edges of the secondary backing 116 may be in the form of, or may comprise, undercut beveled edges, or the like.

Referring back to the example of FIGS. 2 and 3, when the adjacent edges 124 of the finished articles 120, 122 comprise undercut beveled edges of at least the secondary backing 116, and the adjacent edges 124 are engaged against one another to form a seam 126, the initial engagement between the adjacent edges 124 may consist of or consist essentially of engagement between the pile yarns 102 of the adjacent edges 124. That is, the engaging of the adjacent edges 124 against one another may comprise pile yarns 102 of the adjacent edges 124 engaging one another (e.g., substantially engaging one another) prior to (e.g., substantially prior to) the secondary backings 116 of the adjacent edges 124 engaging one another, wherein this staggered or serial engagement seeks to ensure a more seamless appearance of the seams 126.

When the CNC cutting machine is used, the undercut beveled edges may be cut simultaneously with the cutting of the substantially perfectly straight edges and the substantially perfect right angles, or the like. For example and regarding the ultrasonic cutting device carried by the carriage of the CNC apparatus, the cutting blade may comprise an angle, the cutting blade may extend at an angle and/or the ultrasonic cutting device may be held at an angle by a fixture, wherein these angles are relative to vertical and the carpet 100 being cut extends horizontally.

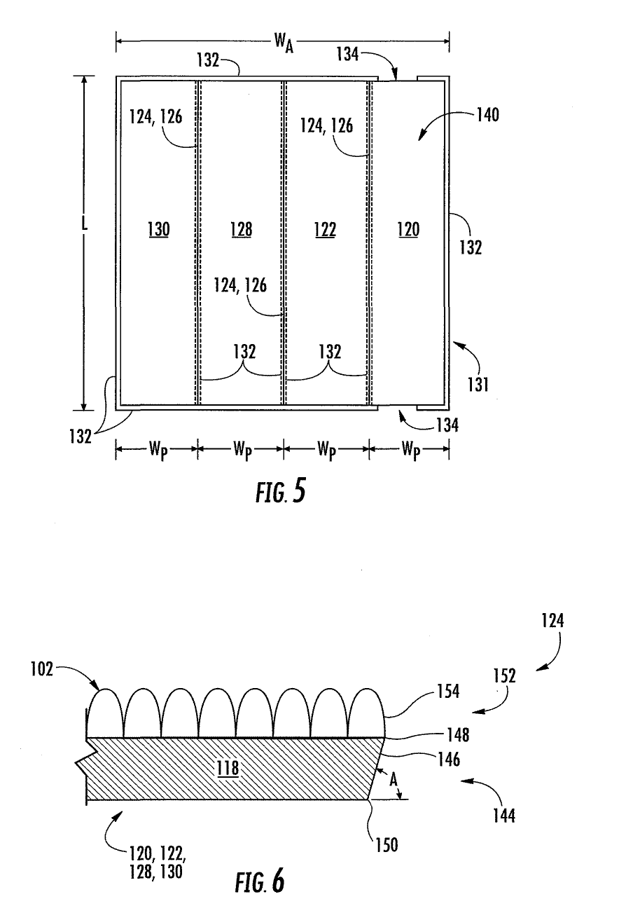

For example and referring to FIG. 6, at least some of or each of the four peripheral side edges of the finished articles 120, 122, 128, 130 may be at least partially undercut and/or beveled. In this regard, FIG. 6 is a cross-sectional view taken through a representative one of the peripheral side edges of the finished articles 120, 122, 128, 130, wherein for example, the cross section may be along any of lines 6-6 of FIG. 2, and anywhere else along the peripheral side edges of the finished articles. In the embodiment shown in FIG. 6, the backing 118 includes a beveled peripheral side edge 144 defining an upright, outwardly-oriented backing side face 146 that extends both along the length (e.g., substantially the entire length) of the finished article (e.g., the finished article 120 or 122) and between the top and bottom surfaces of the backing 118. The backing side face 146 extends obliquely to both of the top and bottom surfaces of the backing 118. For example, an oblique angle A between the backing side face 146 and the substantially planar bottom surface of the backing 118 may be in a range of from about 85 degrees to about 65 degrees, about 80 degrees to about 70 degrees, any range therebetween, about 75 degrees, or any other suitable angle.

In the top plan view of the finished articles 120, 122, 128, 130 in FIGS. 2-5, each of their peripheral side edges 144 (FIG. 6) is substantially hidden from view (by the pile yarns 102) but is otherwise straight. For each of straight peripheral side edges 144, the backing side face 146 thereof may extend straight along a length of the peripheral side edge. Referring to FIG. 6, for each of the straight peripheral side edges 144, the backing side face 146 thereof may be substantially planar, the backing side face may include a top edge 148 that extends along the length of the peripheral side edge and is located at the top surface of the backing 118, and the backing side face may include a bottom edge 150 that extends along the length of the peripheral side edge and is located at the bottom surface of the backing 118. However, variations are within the scope of this disclosure. For example, the peripheral side edges 144 of the finished articles may extend curvilinearly, as will be discussed in greater detail below. Also and as at least alluded to above with reference to FIG. 1A, the beveled side faces 146 may be relegated to the secondary backing 116, such that, for example, one or more of the primary backing 104, precoat layer 106 and intermediate layer 108 may not be undercut and/or beveled. With continued reference to FIG. 6, for each of the finished articles 120, 122, 128, 130, the plurality of yarns 102 has a peripheral yarn side edge 152 defining an upright, outwardly-oriented yarn side face 154 extending both along and upwardly from proximate the backing side face 146.

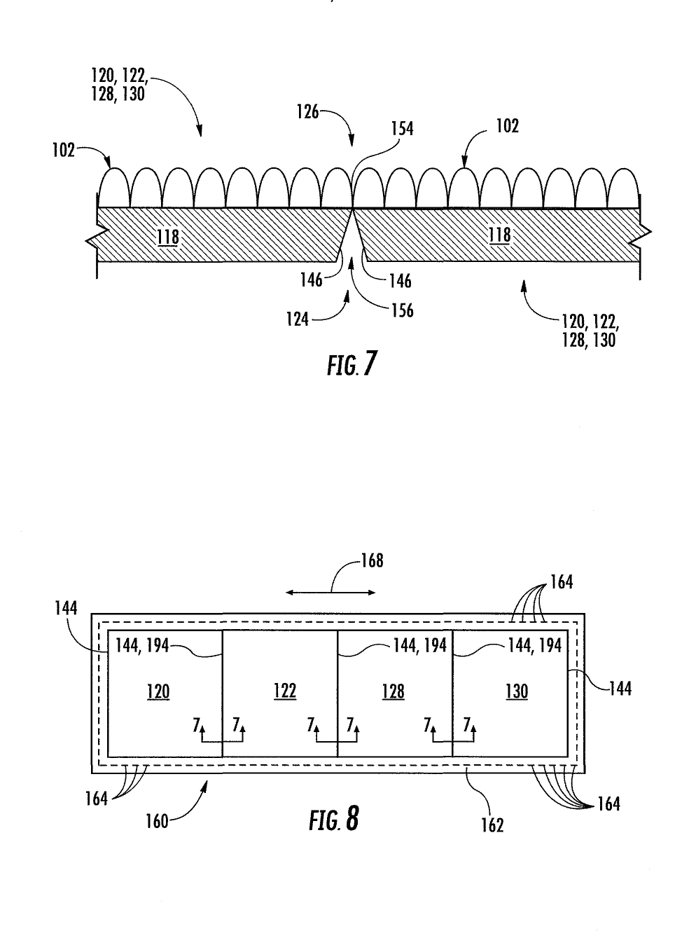

Referring to FIG. 7, at each seam 126 between the finished articles 120, 122, 128, 130, the adjacent edges 124 may be undercut and/or beveled as discussed above. As a result, when the aligned adjacent edges 124 are engaged against one another to form a seam 126, the yarn side faces 154 of the adjacent finished articles 120, 122, 128 or 130 are in opposing face-to-face contact with one another, the backing side faces 146 of the adjacent finished articles are in opposing face-to-face relation with one another, an elongate gap 156 is defined between at least lower portions of the backing side faces of the adjacent finished articles, and the elongate gap extends along the lengths of the adjacent finished articles.

Referring to the top plan view of FIG. 8 and as discussed above, the finished articles 120, 122, 128, 130 may be cut from a textile product or tufted carpet 100 (FIG. 1A) using a CNC cutting machine. For example, the CNC cutting machine may include a downdraft table 160 having a top surface 162 with numerous openings or holes 164 extending therethrough, wherein air is drawn downwardly through the holes by the operation of one or more air movers or fans so that the carpet and finished articles are held securely to the top surface while the air mover(s) are operating. As one example, the CNC cutting machine may be an ultrasonic cutting machine that has a 32 foot downdraft table 160 and is capable of cutting the finished articles 120, 122, 128, 130 in sizes up to 6 feet by 32 feet, although any other suitable cutting machines may be used.

Referring primary to schematic FIG. 9 but also to FIG. 8, the CNC cutting machine may include a laterally extending gantry 166 positioned above the table 160 and movably mounted to a frame for being moved longitudinally, back and forth along the table 160 (e.g., as schematically represented by arrow 168 of FIG. 9) in response to operation of a first computer-controlled actuator. A carriage 170 may be mounted to the gantry 166 for both moving therewith and for being moved laterally, back and forth along the gantry (e.g., as schematically represented by arrow 172 of FIG. 9) in response to operation of a second computer-controlled actuator. A holder 174 may be mounted to the carriage 170 for: moving therewith; for being rotated back and forth relative to the carriage about an upright rotational axis 176 (e.g., as schematically represented by arrow. 178 of FIG. 9) in response to operation of a third computer-controlled actuator; and for being rotated back and forth relative to the carriage about a horizontal rotational axis 180 (e.g., as schematically represented by arrow 182 of FIG. 9) in response to operation of a fourth computer-controlled actuator.

In the embodiment shown in FIG. 9, the CNC cutting machine includes a cutter that may be in the form of an ultrasonic converter 190 that is fixedly held by the holder 174 for traveling with the holder, and a straight ultrasonic knife 192 may be held by the converter for traveling with the converter. The converter 190 may convert electrical signals to ultrasonic vibrations in a conventional manner, so that the knife 192 vibrates ultrasonically and, thus, cuts ultrasonically. As schematically illustrated by dashed lines on opposite sides of the knife 192 in FIG. 9, the fourth computer-controlled actuator may be operated to rotate the holder 174 about the horizontal rotational axis 180 (e.g., as schematically represented by arrow 182 of FIG. 9) to change the inclination of the knife 192 to cut the finished articles 120, 122, 128, 130 so that they include the beveled peripheral side edges 144 (FIG. 6), as discussed above. The computer-controlled actuators of the cutting machine are operated in a coordinated manner so that the cutting machine moves the knife 192 along and, thus cuts, the peripheral side edges 144. Alternatively, the cutting of the side edges 144 may be carried out in other suitable manners, such as through CNC water-jet cutting, CNC laser cutting and/or the like. That is, a cutter may comprise a mechanical knife, a water jet, a laser beam and/or any other suitable cutter.

The CNC cutting machine may have a lesser or greater number of degrees of freedom. For example, the CNC cutting machine may include another computer-controlled actuator that is operatively associated with a respective component of the cutting machine so that the knife 192 may be moved vertically relative to the top surface 162 of the downdraft table 160. As another example and as will be discussed in greater detail below, the knife 192 may include a metal or steel shank that is held and vibrated by the converter 190, and a metal or steel cutting blade may extend from and vibrate with the shank, wherein an oblique angle may be defined between the upright axes of the shank and blade such that the fourth computer-controlled actuator may not be required for pivoting the knife 192 about the horizontal rotational axis 180.

FIG. 7 may also be substantially illustrative of a cross-sectional view taken along any of the cut lines 194 of FIG. 8. In one example, when a cut line 194 having divergently extending backing side face 146 is formed with the knife 192 having a single blade, the cut line requires two passes along the cut line with the knife 192, with the first pass forming the backing side face 146 of one of the adjacent finished articles 120, 122, 128, 130, and the second pass forming the backing side face of the other of the adjacent finished articles.

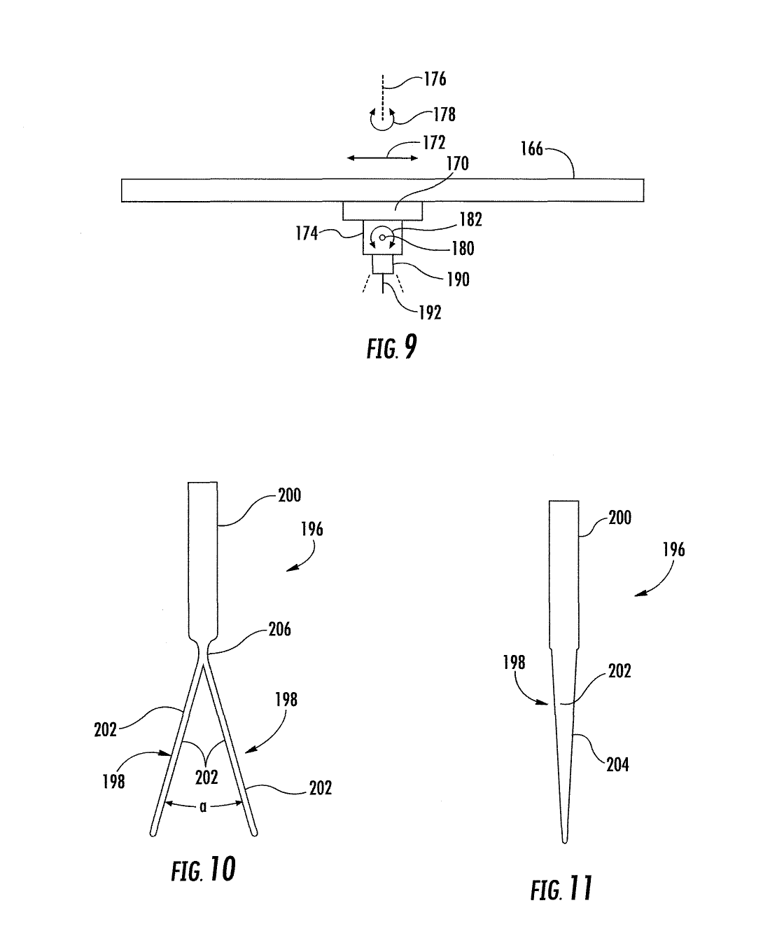

Referring to FIGS. 10 and 11, it is believed that a knife 196 with two divergently extending cutting blades 198 extending fixedly from a shank 130 may be used in place of the knife 192 in the CNC cutting machine to simultaneously cut adjacent backing side faces 146 of adjacent articles 120, 122, 128, 130. The shank 130 is for mounting in the ultrasonic converter 190 (FIG. 9) As apparent from FIGS. 10 and 11, the shank 200 has a length and a longitudinal axis extending along its length, each cutting blade 198 has a longitudinal axis extending along its length, and the longitudinal axes of the cutting blades extend obliquely to the longitudinal axis of the shank. The angle “a” between the blades 198 may be in a range of from about 20 degrees to about 40 degrees, about 25 degrees to about 35 degrees, any range therebetween, about 30 degrees, or any other suitable angle. For each of the blades 198, opposite side faces 202 of the blade may extend rearwardly from a sharpened leading edge 204 of the blade. Optionally, one of the blades 198 may be omitted from the knife 196. A variety of differently configured knives are within the scope of this disclosure.

As discussed above, the seams 126, side edges 144, side faces 146, gaps 156, cut lines 194 and associated features may be straight (e.g., substantially straight). In some examples of this disclosure, such straight side edges 144 may allow for some lateral movement along the seams 126 without the need for seam sealer, yet maintain a seamless appearance.

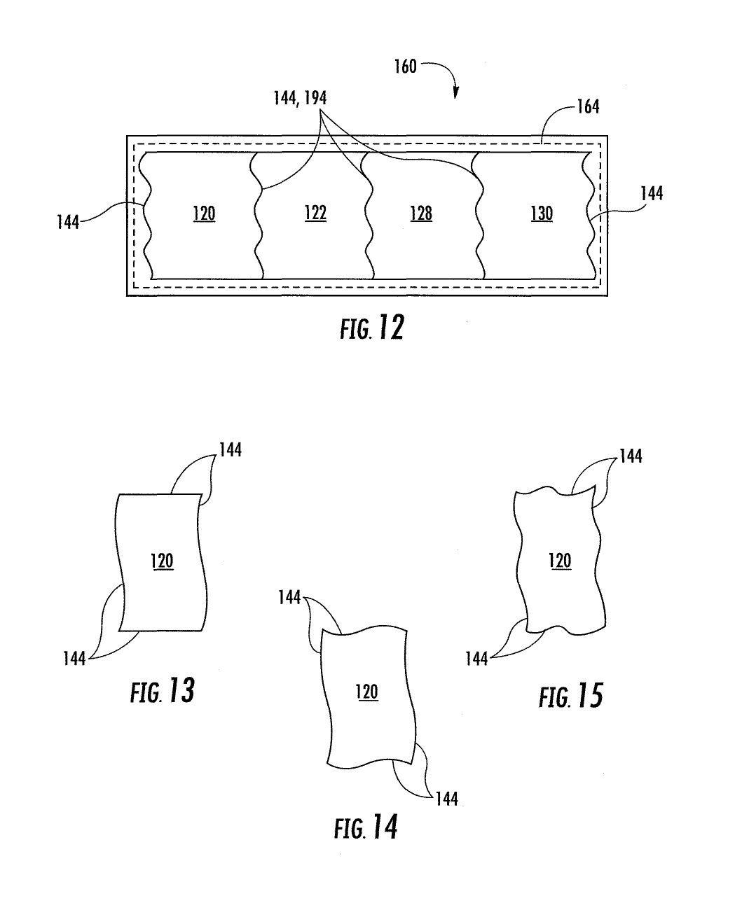

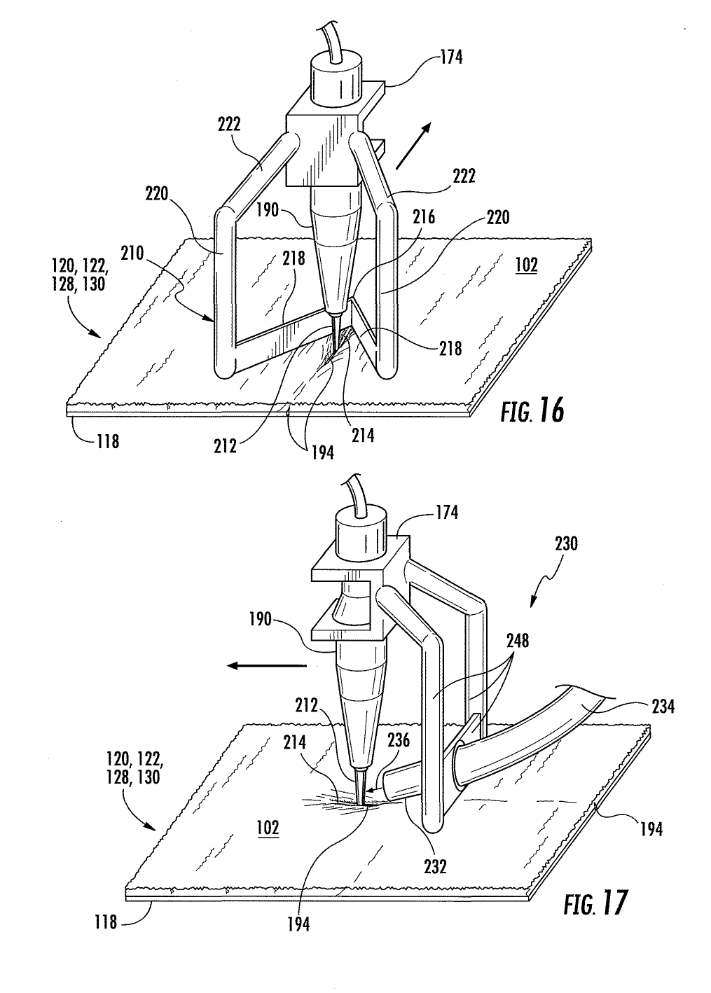

Other embodiments may be as discussed above, except, for example and generally with reference to FIGS. 12-15 and previously described figures, the seams 126, side edges 144, side faces 146, gaps 156, cut lines 194 and associated features may extend curvilinearly (e.g., undulating, sinusoidal, serpentine, etc.). FIG. 12 is like FIG. 8, except that the cut lines 194 between the adjacent finished articles 120, 122, 128, 130 are straight in FIG. 8, whereas they are curvilinear in FIG. 12. FIGS. 13-15 are isolated plan views of examples of representative finished articles 120, 122, 128, 130 with curvilinear side edges 144. In accordance with one aspect of this disclosure, the curved side edges 144 (e.g., see FIGS. 12-15) can be configured for eliminating lateral movement along the seams without the need for seam sealer, while maintaining a seamless appearance.

As mentioned above for an embodiment of this disclosure, the computer-controlled actuators of the cutting machine may be operated in a coordinated manner so that the cutting machine moves the knife 192, 196 along and, thus cuts, the peripheral side edges 144. When the side edges 144 are curvilinear (e.g., see FIGS. 12-15), the third computer-controlled actuator may be operated to rotate the carriage 174 (FIG. 9) about the upright rotational axis 176 (e.g., as schematically represented by arrow 178 of FIG. 8) so that the side faces of the cutting blades (e.g., see side faces 202 of cutting blades 198 in FIGS. 10 and 11) remain substantially tangent to the portion(s) of the backing side face(s) 146 being engaged by the cutting blade(s).

The lengths of the cutting blades (e.g., see cutting blades 198 in FIGS. 10 and 11) may be selected so that the vertical extent of the cutting blades match the thickness of the backing 118 in a manner that seeks to resulting in only cutting of the backing 118 without cutting the pile yarns 102 that extend above the backing 118. For example and referring to FIG. 10, the transition between the shank 200 and the cutting blades 198 may be in the form of a narrow, non-sharpened neck 206 that seeks to temporarily separate the pile yarns 102 along the cut lines 194 in a manner that seeks to avoid any cutting of the pile yarns that extend above the backing 118. For example, the neck 206 may protrude forwardly or a protruding feature connected to the neck or shank 200 may extend forwardly and be referred to as a separator that is transported proximate the knife 196 for at least partially forming a parting line in pile yarns 102, so that the parting line is formed in advance of, and is substantially aligned with, the associated cut line 194 formed in the backing 118 by the knife.

In addition or alternatively, such temporary separation of the pile yarns 102 along the cut lines 194 may be achieved using other mechanical separators or air separators, or the like, that are operative to temporarily physically move the pile yarns 102 away from the cut lines 194 during the cutting, which seeks to avoid any cutting of the pile yarns 102 that extend above the backing 118. Such cutting along the cut lines 194 (e.g., in the above-discussed manner that seeks to minimize any cutting of the pile yarns 102 that extend above the backing 118) helps to allow the pile yarns 102 to substantially effectively hide the seams 126.

For example, FIG. 16 illustrates a portion of the above-discussed CNC cutting machine, wherein a separator 210 is being transported proximate a cutter that may be a knife 212 that is like the above-discussed knives, in accordance with an embodiment of this disclosure. The separator 210 may be carried by the holder 174 of the cutting machine and may be configured for at least partially forming a parting line 214 in the pile yarns 102, so that the parting line is formed in advance of, and is substantially aligned with, the cut line 194 being formed in the backing 118 by the knife 212. In the embodiment shown in FIG. 16, a leading tip or at least a lower end of a leading edge 216 of the separator 210 extends downwardly into the portions of the pile yarns 102 extending upwardly from the backing 118, so that at least the lower portion of the leading edge 216 engages and pushes at least the upper free ends of adjacent yarns 102 away from one another. This separating step is repeated serially as the leading tip or edge 216 progresses forwardly and engages the next respective yarns, so that the parting line 214 advances forwardly in front of the associated forwardly extending cut line 194.

In the embodiment of FIG. 16, the leading edge 216 is defined by connected together or integrally formed forward ends of lower bars 218 that extend divergently rearwardly away from the leading edge 216. The lower bars are inclined upwardly from the leading tip or edge 216, so that the lower bars extend obliquely to the adjacent articles 120, 122, 128 or 130 being cut. Intermediate bars 220 extend respectively upward from the lower bars 218 to upper bars 222, which can extend forwardly and be connected to the holder 174 or another suitable feature of the cutting machine. For example, the separator 210 may be fixedly connected to the holder 174 for simultaneously traveling therewith. The bars 218, 220, 220 may be parts of a metal or steel bar that has been bent accordingly. Alternatively, the leading edge 216 may be formed and supported in any other suitable manner.

FIG. 17 is similar FIG. 16 except, for example, for illustrating a separator 230 in accordance with another embodiment. The embodiments of FIGS. 16 and 17 may be the same, except for variations noted and variations that will be apparent to those of ordinary skill in the art. In the embodiment shown in FIG. 17, the separator 230 includes a nozzle 232 to which fluid (e.g., compressed air) is supplied under pressure from a source by way of a conduit such as tubing 234. The nozzle 232 is configured so that the fluid is discharged from the nozzle in a coherent stream 236 that is inclined downwardly into the yarns 102, so that the stream extends obliquely to the adjacent articles 120, 122, 128 or 130 being cut. The stream 236 engages and pushes at least the upper free ends of adjacent yarns 102 away from one another to form a parting line 214 in the pile yarns 102, so that the parting line is formed at least in advance of, and is substantially aligned with, the cut line 194 being formed in the backing 118 by the knife 212. The nozzle 232 may be fixedly connected, by way of one or more bars 248, to the holder 174 for simultaneously traveling therewith. In FIG. 17, the nozzle 232 is positioned behind the knife 212 and discharges the stream 236 so that the stream impacts the yarns 102 in front of the knife, so that the parting line 214 is formed at least in advance of the cut line 194 being formed in the backing 118 by the knife 212. Alternatively, the nozzle 232 may be positioned, supported and/or configured differently.

The above examples are in no way intended to limit the scope of the present invention. It will be understood by those skilled in the art that while the present disclosure has been discussed above with reference to exemplary embodiments, various additions, modifications and changes can be made thereto without departing from the spirit and scope of the invention, some aspects of which are set forth in the following claims.

What is claimed is:

1. A finished article for covering a floor, the finished article comprising:
an upper layer comprising yarns that extend through a primary backing and are at least partially secured to the primary backing by polymeric material, wherein the yarns at least partially define an exterior upper surface of the finished article;
an intermediate layer connected to the upper layer; and
a secondary backing connected to the intermediate layer so that the intermediate layer is positioned between the upper layer and the secondary backing,
wherein the finished article comprises a plurality of cut peripheral side edges, the plurality of cut peripheral side edges comprises three cut peripheral side edges, at least two of the cut peripheral side edges extend crosswise to one another, and at least one dimension of the finished article selected from a length and a width of the finished article is at least about 3 feet.

2. The finished article of claim 1, wherein the intermediate layer comprises fiberglass scrim.

3. The finished article of claim 1, wherein the at least one dimension is in a range of from about 3 feet to about 67 feet.

4. The finished article of claim 1, wherein the at least one dimension is at least about 6 feet.

5. The finished article of claim 4, wherein the at least one dimension is in a range of from about 6 feet to about 67 feet.

6. The finished article of claim 1, wherein the at least one dimension is at least about 10 feet.

7. The finished article of claim 6, wherein the at least one dimension is in a range of from about 10 feet to about 67 feet.

8. A floor covering comprising the finished article of claim 1, wherein:
the finished article is a first finished article;
the floor cover further comprises a second finished article; and
a lengthwise engagement between a cut peripheral side edge of the plurality of cut peripheral side edges of the first finished article and a cut peripheral side edge of the second finished article extends for at least about 3 feet.

9. The floor covering of claim 8, wherein the lengthwise engagement extends for a length that is in a range of from about 3 feet to about 67 feet.

10. The floor covering of claim 8, wherein the lengthwise engagement extends for a length that is in a range of from about 10 feet to about 67 feet.

11. A finished article for covering a floor, the finished article comprising:
a backing having opposite top and bottom surfaces, the backing comprising a textile web and polymeric material; and
a plurality of yarns extending upwardly from the backing, wherein the yarns extend through the textile web and are at least partially secured to the textile web by the polymeric material,
wherein the backing includes a peripheral side edge defining an upright, outwardly-oriented side face extending both along a length of the finished article and between the top and bottom surfaces of the backing, and the side face extends obliquely to both of the top and bottom surfaces of the backing.

12. The finished article of claim 11, wherein the side face extends from the top surface of the backing to the bottom surface of the backing.

13. The finished article of claim 11, wherein the side face extends straight along a length of the peripheral side edge.

14. The finished article of claim 11, wherein the side face extends curvilinearly along a length of the peripheral side edge.

15. The finished article of claim 11, wherein the side face is substantially planar and includes:
a top edge extending along a length of the peripheral side edge and located at the top surface of the backing; and
a bottom edge extending along a length of the peripheral side edge and located at the bottom surface of the backing.

16. The finished article of claim 11, wherein:
the side edge is a first side edge;
the backing further comprises second, third and fourth side edges;
the first and second side edges are spaced apart from one another;
the third and fourth side edges are spaced apart from one another;
the third and fourth side edges each extend between the first and second side edges; and
for each side edge of the second, third and fourth side edges, the side edge defines an upright, outwardly-oriented side face extending between the top and bottom surfaces of the backing, and the side face extends obliquely to both of the top and bottom surfaces of the backing.

17. A floor covering, comprising:
a plurality of articles covering a floor, wherein
the plurality of articles comprises first and second articles that each comprise
a backing having opposite top and bottom surfaces, and
a plurality of yarns connected to the backing and extending upwardly from the top surface of the backing;
for each article of the first and second articles, the backing of the article includes a peripheral side edge defining an upright, outwardly-oriented backing side face extending both along a length of the article and between the top and bottom surfaces of the backing, and the backing side face extends obliquely to both of the top and bottom surfaces of the backing;
for each article of the first and second articles, the plurality of yarns of the article has a peripheral side edge defining an upright, outwardly-oriented yarn side face extending both along and upwardly from proximate the backing side face of the article;
the yarn side face of the first article is in opposing face-to-face engagement with the yarn side face of the second article along the lengths of the first and second articles;
the backing side face of the first article is in opposing face-to-face relation with the backing side face of the second article along the lengths of the first and second articles;
an elongate gap is defined between at least a lower portion of the backing side face of the first article and a lower portion of the backing side face of the second article; and
the elongate gap extends along the lengths of the first and second articles.

18. The floor covering of claim 17, wherein the yarn side faces, the backing side faces and the gap each extend straight along lengths of the first and second articles.

19. The floor covering of claim 17, wherein the yarn side faces, the backing side faces and the gap each extend curvilinearly along lengths of the first and second articles.

20. The floor covering of claim 17, wherein the face-to-face engagement extends for a length that is in a range of from about 3 feet to about 67 feet.

21. The floor covering of claim 17, wherein the face-to-face engagement extends for a length that is in a range of from about 6 feet to about 67 feet.

22. The floor covering of claim 17, wherein the face-to-face engagement extends for a length that is in a range of from about 10 feet to about 67 feet.

23. A method for at least partially forming an article configured for covering a floor; the method comprising:
cutting a peripheral side edge of the article, wherein
the article comprises
a backing having opposite top and bottom surfaces, and
a plurality of yarns connected to the backing and extending upwardly from the top surface of the backing;
the cutting of the peripheral side edge is comprised of cutting so that the peripheral side edge comprises an upright, outwardly-oriented side face extending both along a length of the article and between the top and bottom surfaces of the backing, and the side face extends obliquely to both of the top and bottom surfaces of the backing; and
the cutting of the peripheral side edge is comprised of a computerized cutting machine moving a cutter along a length of the peripheral side edge to cut the peripheral side edge.

24. The method of claim 23, wherein:
the cutting of the peripheral side edge is comprised of the moving cutter forming at least one cut line in the backing; and
the method further comprises at least partially forming a parting line in the yarns in advance of the moving cutter, so that the parting line is formed in advance of, and is substantially aligned with, the cut line being formed in the backing by the moving cutter.

25. The method of claim 23, wherein:
wherein the side face extends curvilinearly along a length of the peripheral side edge; and
the method further comprises rotating the cutter during the moving of the cutter along a length of the peripheral side edge so that a cutting blade of the cutter is substantially tangent to a portion of the side face being engaged by the cutting blade.

26. The method of claim 23, wherein:
the article is a first article;
the method comprises separating the first article from a second article;
the separating of the first article from the second article is comprised of the cutting of the peripheral side edge of the first article;
the method comprises cutting a peripheral side edge of the second article;
the second article comprises
a backing having opposite top and bottom surfaces, and
a plurality of yarns connected to the backing of the second article and extending upwardly from the top surface of the backing of the second article; and
the cutting of the peripheral side edge of the second article is comprised of cutting the second article so that the peripheral side edge of the second article comprises an upright, outwardly-oriented side face extending both along a length of the second article and between the top and bottom surfaces of the backing of the second article, and the side face of the second article extends obliquely to both of the top and bottom surfaces of the backing of the second article.

27. The method of claim 26, further comprising at least partially assembling a floor covering wherein:
for each article of the first and second articles, the plurality of yarns of the article has a peripheral side edge defining an upright, outwardly-oriented yarn side face extending both along and upwardly from proximate the backing side face; and
the at least at least partially assembling of the floor covering is comprised of arranging the first and second articles so that
the yarn side face of the first article is in opposing face-to-face contact with the yarn side face of the second article along the lengths of the first and second articles;
the backing side face of the first article is in opposing face-to-face relation with the backing side face of the second article along the lengths of the first and second articles;
an elongate gap is defined between at least a lower portion of the backing side face of the first article and the backing side face of the second article; and
the elongate gap extends along the lengths of the first and second articles.

28. The method of claim 26, wherein the cutting of the peripheral side edge of the first article and the cutting of the peripheral side edge of the second article occur simultaneously.

29. The method of claim 28, wherein the simultaneous cutting of the peripheral side edges of the first and second articles is comprised of simultaneously:
moving the cutter along the lengths of the first and second articles;
cutting the peripheral side edge of the first article with a first cutting blade of the cutter; and
cutting the peripheral side edge of the second article with a second cutting blade of the cutter.

30. The method of claim 29, wherein:
the first and second cutting blades are connected to a shank of the cutter; and
the simultaneous cutting comprises ultrasonically vibrating the shank of the cutter so that the first and second cutting blades are ultrasonically vibrated.

31. A method for at least partially forming an article configured for covering a floor; the method comprising:
cutting a peripheral side edge of the article, wherein
the article comprises
a backing having opposite top and bottom surfaces, and
a plurality of yarns connected to the backing and extending
upwardly from the top surface of the backing, and
the cutting of the peripheral side edge is comprised of a computerized cutting machine moving a cutter so that the cutter forms at least one a cut line in the backing; and
at least partially forming a parting line in the yarns in advance of the moving cutter, so that the parting line is formed in advance of, and is substantially aligned with, the cut line being formed in the backing by the moving cutter.

32. The method of claim 31, wherein the at least partially forming of the parting line is comprised of the computerized cutting machine simultaneously moving at least one separator with the cutter, so that the at least one separator at least partially foams the cut line.

33. The method of claim 31, wherein the at least partially forming of the parting line is comprised of the computerized cutting machine simultaneously moving at least one separator with the cutter, and the at least one separator at least partially forming the parting line.

34. The method of claim 31, wherein the at least one separator at least partially forming the parting line is comprised of the at least one separator engaging and pushing adjacent yarns away from one another.

35. The method of claim 31, wherein the at least one separator at least partially forming the parting line is comprised of the at least one separator providing fluid that engages and pushes adjacent yarns away from one another.

36. A knife apparatus, comprising:
a shank having length and a longitudinal axis extending along the length of the shank; and
a cutting blade extending fixedly from the shank, the cutting blade having a longitudinal axis extending along a length of the cutting blade, wherein
the longitudinal axis of the cutting blade extends obliquely to the longitudinal axis of the shank.

37. The knife apparatus of claim 36, wherein:
the cutting blade is a first cutting blade;
the knife apparatus further comprises a second cutting blade extending fixedly from the shank;
the second cutting blade has a longitudinal axis extending along a length of the second cutting blade;
the longitudinal axis of the second cutting blade extends obliquely to the longitudinal axis of the shank; and
the longitudinal axes of the first and second blades extend divergently from one another in a direction away from the shank.
